(19) United States
(12) Patent Application Publication
(10) Pub. No.: US 2017/0036494 A1
(43) Pub. Date: Feb. 9, 2017

(54) SIDE-REINFORCEMENT-TYPE RUN-FLAT RADIAL TIRE

(71) Applicant: BRIDGESTONE CORPORATION, Chuo-ku, Tokyo (JP)

(72) Inventor: Gaku OGAWA, Chuo-ku, Tokyo (JP)

(21) Appl. No.: 15/304,065

(22) PCT Filed: Feb. 6, 2015
(86) PCT No.: PCT/JP2015/053397

§ 371 Date: Oct. 14, 2016

(30) Foreign Application Priority Data
Apr. 18, 2014 (JP) 2014-086794

(51) Int. Cl. B60C 17/00; B60C 9/20; B60C 9/30

(52) U.S. Cl. CPC B60C 17/0009; B60C 9/30; B60C 9/20; B60C 2017/0072; B60C 2009/2012

(57) ABSTRACT

A run-flat radial tire is provided with a side reinforcement rubber layer that extends in the tire radial direction along an inner face of a carcass and an angled belt layer that is provided at the tire radial direction outer side of the carcass. An overlap length L between a maximum width angled belt layer and the side reinforcement rubber layer satisfies the relationship L>0.14× SH with a tire section height SH. A thickness GD of the side reinforcement rubber layer at a position that is 14% of the tire section height to the tire axial direction inner side from a tire axial direction end portion of the maximum width angled belt layer and a thickness GA of the side reinforcement rubber layer at a maximum width position of the carcass satisfy the relationship GD/GA≧0.3.

### TECHNICAL FIELD

The present invention relates to a side-reinforced type run-flat radial tire.

### BACKGROUND ART

As a run-flat radial tire that may run safely for a certain distance in a state in which internal pressure is reduced due to a puncture or the like, Japanese Patent Application Laid-Open (JP-A) No. 2009-126262 has disclosed a side-reinforced type run-flat radial tire in which a tire side portion is reinforced by a side reinforcement rubber layer.

### SUMMARY OF INVENTION

### Technical Problem

However, side-reinforced type run-flat radial tires are generally tires of a size with a relatively small tire section height. This is because the level of performance required of a run-flat radial tire is more demanding as tire section height increases, because a tire deformation amount when a slip angle is applied during run-flat running (running in a state in which internal pressure is reduced due to a puncture or the like) is greater.

In particular, a side-reinforced type run-flat radial tire with a large tire section height is susceptible to roll-off at the steering inner side of a vehicle.

This is thought to be because roll-off at the steering inner side of the vehicle is caused by buckling of a tire side portion at the steering inner side of the vehicle (a phenomenon of the tire side portion folding over at the tire inner side).

An object of the present invention is to further improve roll-off resistance of a side-reinforced type run-flat radial tire.

### Solution to Problem

A side reinforced-type run-flat radial tire according to a first aspect of the present invention includes: a carcass that bridges between a pair of bead portions; a side reinforcement rubber layer that is provided at a tire side portion and extends in a tire radial direction along an inner face of the carcass; and angled belt layers that are provided at the tire radial direction outer side of the carcass and are provided with cords extending in directions that are angled with respect to a tire circumferential direction, wherein the following relationships (1) and (2) are satisfied and a tire section height is at least 115 mm:

L>0.14×SH (1)

GD/GA≧0.3 (2)

in which relationships,

L represents an overlap length in a tire axial direction, at one side, between the side reinforcement rubber layer and the angled belt layer whose width in the tire axial direction is largest (a maximum width angled belt layer),

SH represents the tire section height,

GD represents a thickness of the side reinforcement rubber layer at a position that is 14% of the tire section height to the tire axial direction inner side from a tire axial direction end portion of the maximum width angled belt layer, and

GA represents a thickness of the side reinforcement rubber layer at a maximum width position of the carcass.

### Advantageous Effects of Invention

The run-flat radial tire of the present invention may improve roll-off resistance.

### BRIEF DESCRIPTION OF DRAWINGS

FIG. 1 is a tire half-section diagram showing one side of a sectional plane in which a run-flat radial tire in accordance with an exemplary embodiment of the present invention is cut along the tire axial direction.

FIG. 2 is a tire sectional diagram showing a section in which the run-flat radial tire shown in FIG. 1 is cut along the tire axial direction in a state in which a tire side portion is buckled.

FIG. 3 is a tire half-section diagram showing one side of a sectional plane in which a run-flat radial tire in accordance with an exemplary embodiment of the present invention is cut along the tire axial direction.

FIG. 4 is a descriptive diagram describing a mechanism by which roll-off occurs at the steering inner side of a vehicle in accordance with a Comparative Example.

FIG. 5 is a graph showing a relationship between tire section height and roll-off resistance of run-flat tires.

### DESCRIPTION OF EMBODIMENTS

Herebelow, an exemplary embodiment of the present invention is described in accordance with the drawings.

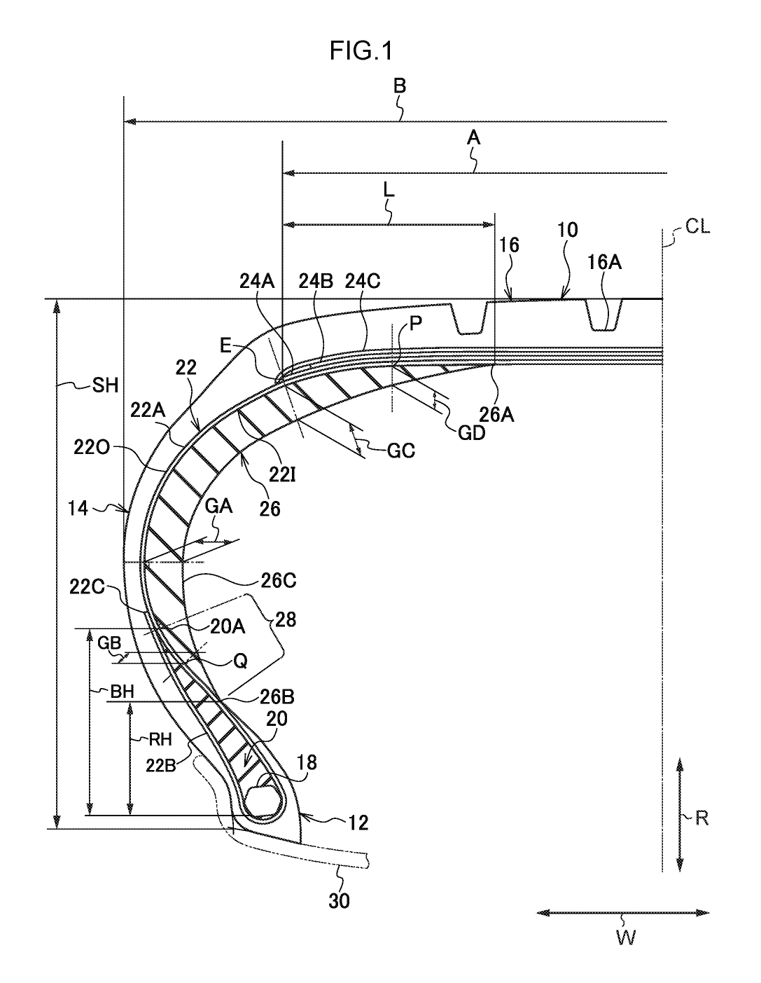

FIG. 1 shows one side of a section cut along a tire axial direction of a run-flat radial tire 10 according to an exemplary embodiment of the present invention (below referred to simply as “the tire 10”). The arrow W in FIG. 1 indicates the axial direction of the tire 10 (below recited where appropriate as “the tire axial direction”). The arrow R indicates a diametric direction of the tire 10 (below recited where appropriate as “the tire radial direction”). The symbol CL indicates an equatorial plane of the tire 10 (below recited where appropriate as “the tire equatorial plane”). In the present exemplary embodiment, the axis (rotation axis) side of the tire radial direction of the tire 10 is recited as “the tire radial direction inner side”, and the opposite side from the axis side of the tire radial direction of the tire 10 is recited as “the tire radial direction outer side”. The equatorial plane CL side of the tire axial direction of the tire 10 is recited as “the tire axial direction inner side”, and the opposite side from the equatorial plane CL side of the tire axial direction of the tire 10 is recited as “the tire axial direction outer side”.

The tire 10 shown in FIG. 1 is mounted to a standard rim 30 (shown by the two-dot chain lines in FIG. 1) and filled to a standard air pressure. The standard rim referred to here is a rim specified in the Japan Automobile Tire Manufacturers Association, Inc. (JATMA) Year Book 2013. The standard tire pressure mentioned above is an air pressure corresponding to a maximum load capacity in the JATMA Year Book 2013.

Outside Japan, the term “weight” refers to the maximum weight (maximum load capacity) on a single wheel of an applicable size recited in the below-mentioned standards, the term “internal pressure” refers to an air pressure corresponding to the maximum weight (maximum load capacity) on a single wheel recited in the below-mentioned standards, and the term “rim” refers to a standard rim (or “approved rim” or “recommended rim”) with an applicable size recited in the below-mentioned standards. These standards are defined by the applicable industrial standards in the regions in which tires are manufactured and used. For example, in the United States of America, the standards defined in “The Tire and Rim Association Inc.'s Year Book”, in Europe, the “European Tire and Rim Technical Organization's Standards Manual”, and in Japan, the “JATMA Year Book”.

It is sufficient that the tire 10 according to the present exemplary embodiment is a tire with a tire section height of at least 115 mm; for example, the tire 10 may have a tire section height of 129 mm.

As shown in FIG. 1, the run-flat radial tire 10 according to the present exemplary embodiment includes a pair of bead portions 12 (only the bead portion 12 at one side is shown in FIG. 1), a pair of tire side portions 14 that extend to the tire radial direction outer side from the respective bead portions 12, and a tread portion 16 that extends between one of the tire side portions 14 and the other of the tire side portions 14. The tire side portions 14 bear loads that act on the tire 10 during run-flat running.

A respective bead core 18 is embedded in each of the pair of bead portions 12. A carcass 22 bridges between the pair of bead cores 18. Each end portion side of the carcass 22 is anchored by the bead core 18. The end portion side of the carcass 22 is folded back around the bead core 18 from the tire inner side to the tire outer side and anchored, and an end portion 22C of a folded-back portion 22B thereof is in contact with a carcass main body portion 22A. The carcass 22 extends in a toroidal shape from one of the bead cores 18 to the other of the bead cores 18 to structure a framework of the tire.

At the tire radial direction outer side of the carcass main body portion 22A, a belt layer 24A and a belt layer 24B are layered in this order from the tire radial direction inner side, and a cap layer 24C is layered over the belt layers 24A and 24B. The belt layer 24A and belt layer 24B have ordinary structures in which plural numbers of steel cords are arrayed in parallel with one another and coated with rubber. The steel cords of the belt layer 24A and the steel cords of the belt layer 24B are arranged to be angled in opposite directions with respect to the equatorial plane CL, and cross one another. Of the belt layer 24A and belt layer 24B in the present exemplary embodiment, the belt layer 24A has a greater width in the tire axial direction and corresponds to a “maximum width angled belt layer” of the present invention.

A width A of the maximum width angled belt layer (the belt layer 24A) in the tire axial direction is preferably not less than 90% and not more than 115% of a tread width. The term “tread width” used here refers to a tire axial direction width of a contact patch under a maximum loading weight in the state in which the tire 10 is assembled to the standard rim 30 and the internal pressure is set to the standard air pressure. The term “maximum loading weight” refers to the maximum loading weight according to the JATMA Year Book 2013.

A bead filler 20 is embedded in the bead portion 12. The bead filler 20 extends from the bead core 18 toward the tire radial direction outer side along an outer face 220 of the carcass 22. The bead filler 20 is disposed in a region that is enclosed between the carcass main body portion 22A and the folded-back portion 22B. A thickness of the bead filler 20 decreases toward the tire radial direction outer side. An end portion 20A at the tire radial direction outer side of the bead filler 20 is inserted at the tire side portion 14.

As shown in FIG. 1, a height BH of the bead filler 20 is preferably not less than 30% and not more than 50% of a tire section height SH. In the present exemplary embodiment, the height BH is set to 42% of the tire section height SH.

The term “tire section height SH” as used herein represents half the difference in length between the tire outer diameter and the rim diameter in an unloaded state, as defined in the JATMA Year Book. The term “height BH of the bead filler” refers to a length measured in the tire radial direction from a lower end (a tire radial direction inner side end portion) of the bead core 18 to the end portion 20A of the bead filler 20, in the state in which the tire 10 is assembled to the standard rim 30 and the internal pressure is set to the standard air pressure.

A side reinforcement rubber layer 26 is disposed at the tire side portion 14, at the tire axial direction inner side of the carcass 22. The side reinforcement rubber layer 26 reinforces the tire side portion 14. The side reinforcement rubber layer 26 extends in the tire radial direction along an inner face 221 of the carcass 22. The side reinforcement rubber layer 26 is formed substantially in a crescent shape whose thickness decreases toward the side at which the bead core 18 is disposed and toward the side at which the tread portion 16 is disposed. The term “thickness of the side reinforcement rubber” used herein refers to a length measured along a line perpendicular to the carcass 22, in the state in which the tire 10 is assembled to the standard rim 30 and the internal pressure is set to the standard air pressure.

An end portion 26A of the side reinforcement rubber layer 26 at the side thereof at which the tread portion 16 is disposed overlaps with the belt layer 24A, sandwiching the carcass 22 (the carcass main body portion 22A) therebetween. An end portion 26B of the side reinforcement rubber layer 26 at the side thereof at which the bead core 18 is disposed overlaps with the bead filler 20, sandwiching the carcass 22 therebetween.

Viewed in the tire radial direction, an overlap length L in the tire axial direction between the side reinforcement rubber layer 26 and the belt layer 24A is specified to be greater than 14% of the tire section height SH. In other words, the relationship L>0.14× SH is satisfied.

As shown in FIG. 1, a thickness GB of the side reinforcement rubber layer 26 at a midpoint Q between the end portion 20A of the bead filler 20 and the end portion 26B of the side reinforcement rubber layer 26 in the direction of extension of the carcass 22 is preferably not more than 50% of a thickness GA of the side reinforcement rubber layer 26 at a maximum width position of the carcass 22 (which may below be referred to as “the maximum thickness GA”). In the present exemplary embodiment, the thickness GB is set to 30% of the thickness GA.

The term “maximum width position of the carcass” used herein refers to a position in the tire radial direction at which the carcass 22 is furthest to the tire axial direction outer side.

Furthermore, the thickness GC of the side reinforcement rubber layer 26 at a tire axial direction end portion E of the belt layer 24A, which is the maximum width angled belt layer, is preferably not less than 90% of the maximum thickness GA. In other words, it is preferable if the relationship GC/GA≧0.9 is satisfied.

A thickness GD of the side reinforcement rubber layer 26 at a position P that is at the tire axial direction inner side from the tire axial direction end portion E of the belt layer 24A by 14% of the tire section height SH is specified to be not less than 30% of the maximum thickness GA. In other words, the relationship GD/GA≧0.3 is satisfied.

A tire radial direction distance RH between a lower end (tire radial direction inner side end portion) of the bead core 18 and the end portion 26B of the side reinforcement rubber layer 26 is preferably not less than 50% and not more than 80% of the bead filler height BH. In the present exemplary embodiment, the distance RH is 65% of the height BH.

The term “tire radial direction distance RH” refers to a length measured in the tire radial direction from the lower end (the tire radial direction inner side end portion) of the bead core 18 to the end portion 26B of the side reinforcement rubber layer 26, in the state in which the tire 10 is assembled to the standard rim 30 and the internal pressure is set to the standard air pressure.

The side reinforcement rubber layer 26 is a rubber member for enabling running over a predetermined distance in a state of supporting the weight of the vehicle and vehicle occupants when the internal pressure of the tire 10 has decreased due to a puncture or the like.

Plural circumferential direction grooves 16A that extend in the tire circumferential direction are formed in the tread portion 16. An inner liner, which is not shown in the drawings, is arranged over the inner face of the tire 10 from the one of the bead portions 12 to the other of the bead portions 12. Butyl rubber is a principal component of the inner liner. The principal component of the inner liner may be a resin.

Because the tire 10 has a large tire section height, a tire section height of at least 115 mm, no rim guard is provided in the present exemplary embodiment. However, a rim guard may be provided.

Now, operation of the tire 10 according to the present exemplary embodiment is described.

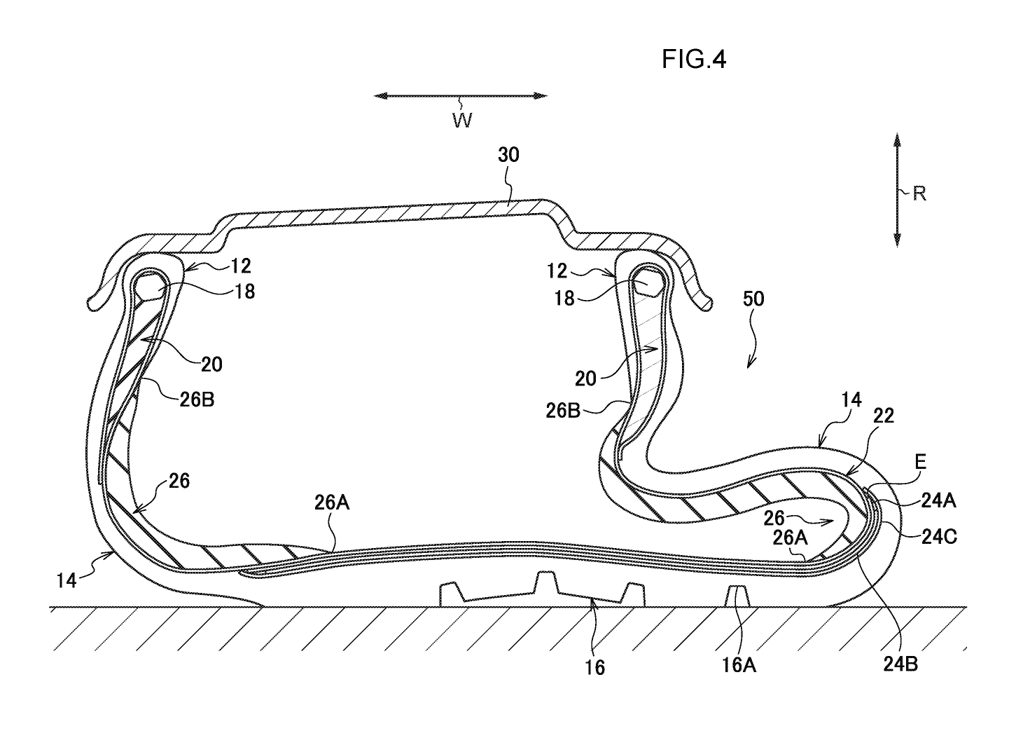

First, a mechanism by which roll-off occurs at the tire 10 is briefly described. The description is given using a tire 50 (see FIG. 4) as a comparative example. The tire 50 has the same structure as the tire 10 except that the overlap length L in the tire axial direction between the side reinforcement rubber layer 26 and the belt layer 24A, which is the maximum width angled belt layer, is 14% of the tire section height SH. Structural elements that are substantially the same as in the tire 10 are assigned the same reference symbols.

As shown in FIG. 4, when a slip angle is applied to the tire 50 during run-flat running, for example, by steering, the contact patch of the tire 50 is crushed, a warp amount of the contact patch increases, and a belt radius at a depression portion of the tire 50 increases. As a result, a tensile force at a depression position at the tire radial direction outer side relative to the bead portion 12 that is disposed at the steering inner side increases, which, combined with buckling that occurs at the depression position of the tire side portion 14 that is disposed at the steering inner side of the vehicle, may cause the bead portion 12 to disengage from the standard rim 30 (roll-off).

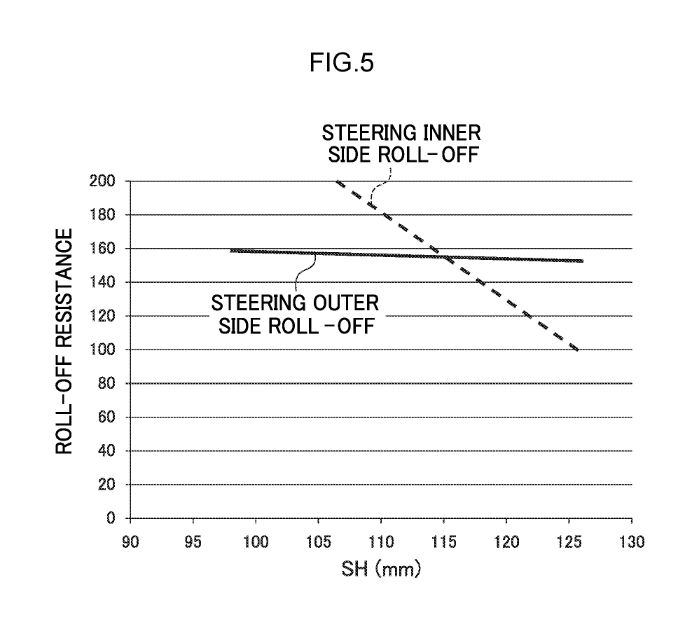

As shown in FIG. 5, it has been verified that roll-off at the steering inner side of a vehicle is more likely to occur with a tire whose tire section height SH is 115 mm or more. In the graph shown in FIG. 5, a roll-off index is measured in relation to the tire section height SH using run-flat radial tires of which the tire width is 215 mm and the tire section height SH is varied. The greater the value of the roll-off index, the less likely buckling is to occur. According to FIG. 5, it can be seen that for a tire whose tire section height SH is less than 115 mm, the main factor is that rim-off is more likely at the steering outer side of the tire, and rim-off at the steering inner side is suppressed in a tire whose tire section height is 115 mm or more. In concrete terms, the tire section height is not more than 250 mm, and specifically not more than 155 mm.

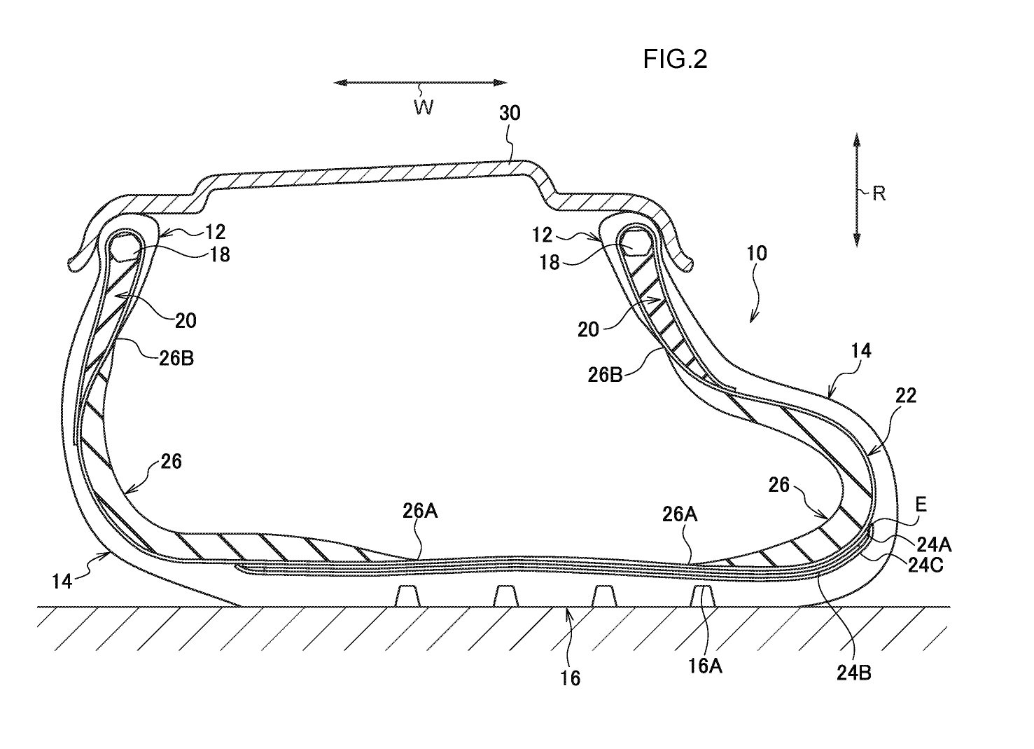

However, in the tire 10 according to the present exemplary embodiment, the overlap length L between the side reinforcement rubber layer 26 and the belt layer 24A in the tire axial direction is greater than 14% of the tire section height (see FIG. 1). Moreover, the thickness GD of the side reinforcement rubber layer 26 at the position P that is 14% of the tire section height SH to the tire axial direction inner side from the tire axial direction end portion E of the belt layer 24A, which is the portion that is most susceptible to bending at a time of buckling, is set to not less than 30% of the maximum thickness GA. Therefore, even when a slip angle is applied during run-flat running, because the bending stiffness of the belt layer 24A in the vicinity of position P is improved, bending of the belt layer 24A in the vicinity of position P is suppressed (see FIG. 2). Hence, occurrences of buckling of the tire side portion 14 are suppressed and an improvement in roll-off resistance may be achieved.

A tire of which the tire section height is 115 mm or more, such as the tire 10 according to the present exemplary embodiment, is susceptible to buckling at the tire side portion 14. Accordingly, buckling of the tire side portion 14 of the tire 10 with a tire section height of 115 mm or more may be effectively suppressed by setting the overlap length L between the side reinforcement rubber layer 26 and the belt layer 24A in the tire axial direction to be greater than 14% of the tire section height. In the case of a tire with a specified vehicle mounting direction, the thickness GD of the side reinforcement rubber layer 26 that is at the vehicle mounting direction outer side may be set to be less than 30% of the thickness GA.

If a tire axial direction width A of the maximum width angled belt layer (the belt layer 24A) is 80% or more of a tire section width B, bending stiffness of the tread portion 16 is improved over an even wider range. Consequently, buckling of the tire side portion 14 may be suppressed and roll-off resistance may be improved.

Buckling may be further suppressed by lengthening the overlap length L between the side reinforcement rubber layer 26 and the belt layer 24A to the tire width direction outer side. Occurrences of buckling may be even further suppressed by, for example, setting the thickness GD of the side reinforcement rubber layer 26 at position P to 30% or more of the maximum thickness GA. Consequently, roll-off resistance may be further improved.

The bending stiffness of the belt layer 24A of the tire 10 in the vicinity of the tire axial direction end portion E may be further improved by specifying the thickness GC of the side reinforcement rubber layer 26 at the tire axial direction end portion E of the belt layer 24A to be 90% or more of the maximum thickness GA. Consequently, roll-off resistance may be further improved.

In the tire 10, the end portion 26B of the side reinforcement rubber layer 26 that sandwiches the carcass 22 overlaps with the bead filler 20. Therefore, bending stiffness of the tire side portion 14 may be increased and run-flat endurance may be improved.

In the tire 10, because the height BH of the bead filler 20 is set to 42% of the tire section height SH (i.e., not less than 30% and not more than 50%), both riding comfort and run-flat endurance may be achieved. That is, if the height BH of the bead filler 20 were less than 30% of the tire section height SH, stiffness of the bead portion 12 would be low and the bead portion 12 would deform easily. Consequently, the tire would be susceptible to damage and the like, and run-flat endurance would deteriorate. On the other hand, if the height BH of the bead filler 20 were more than 50% of the tire section height SH, stiffness of the bead portion 12 would be excessively high, as a result of which riding comfort would deteriorate.

In the tire 10, the thickness of the side reinforcement rubber layer 26 decreases toward the side at which the bead core 18 is disposed and toward the side at which the tread portion 16 is disposed. The thickness GB of the side reinforcement rubber layer 26 at the midpoint Q of an overlap portion 28 is set to 30% (i.e., not more than 50%) of the thickness GA of the side reinforcement rubber layer 26 at the maximum width position of the carcass 22. Consequently, even if side-buckling occurs, damage to the side reinforcement rubber layer 26 is suppressed. This is because the distance from the carcass 22 at the midpoint Q of the overlap portion 28 to an inner face 26C of the side reinforcement rubber layer 26 is shortened, and thus tensile stress acting on the inner face 26C is lowered.

In the tire 10, the tire radial direction distance RH between the lower end (the tire radial direction inner side end portion) of the bead core 18 and the end portion 26B of the side reinforcement rubber layer 26 is set to 65% (i.e., not less than 50% and not more than 80%) of the bead filler height BH. Consequently, both riding comfort and run-flat endurance may be achieved. That is, if the tire radial direction distance RH were less than 50% of the height BH, stiffness of the bead portion 12 would be too high and riding comfort would deteriorate. On the other hand, if the tire radial direction distance RH were greater than 80% of the height BH, stiffness of the bead portion 12 would be lower and run-flat endurance would deteriorate.

The present exemplary embodiment has a structure in which each end portion side of the carcass 22 is folded back around the bead core 18 from the tire axial direction inner side to the outer side and the end portion of the carcass 22 is anchored at the bead core 18, but the present invention is not limited to this structure. For example, a structure is possible in which the bead core 18 is divided in half and the end portion of the carcass 22 is anchored at the bead core 18 by the end portion side of the carcass 22 being sandwiched by the halves of the bead core 18.

In the present exemplary embodiment, the side reinforcement rubber layer 26 is structured of a single type of rubber but, provided rubber is a principal component, the side reinforcement rubber layer 26 may also include a filler, short fibers, resin or the like.

The side reinforcement rubber layer 26 may also be structured of plural types of rubber. For example, the side reinforcement rubber layer 26 may have a structure in which plural different types of rubber are superposed in the tire radial direction or the tire axial direction. The effects of the present invention may be provided even when the side reinforcement rubber layer 26 has a structure in which plural different types of rubber are superposed in the tire radial direction. That is, it is sufficient if the overlap length L is greater than 14% of the tire section height SH and a total thickness of the side reinforcement rubber layer 26 at position P is at least 30% of the thickness GA of the side reinforcement rubber layer 26.

An alternative material may be used instead of the rubber of the side reinforcement rubber layer 26 according to the present exemplary embodiment. For example, use of a thermoplastic resin can be considered.

If the carcass 22 has plural layers, the side reinforcement rubber layer 26 may be provided between the layers of the carcass 22 and between the carcass 22 and the inner liner.

### Alternative Exemplary Embodiment

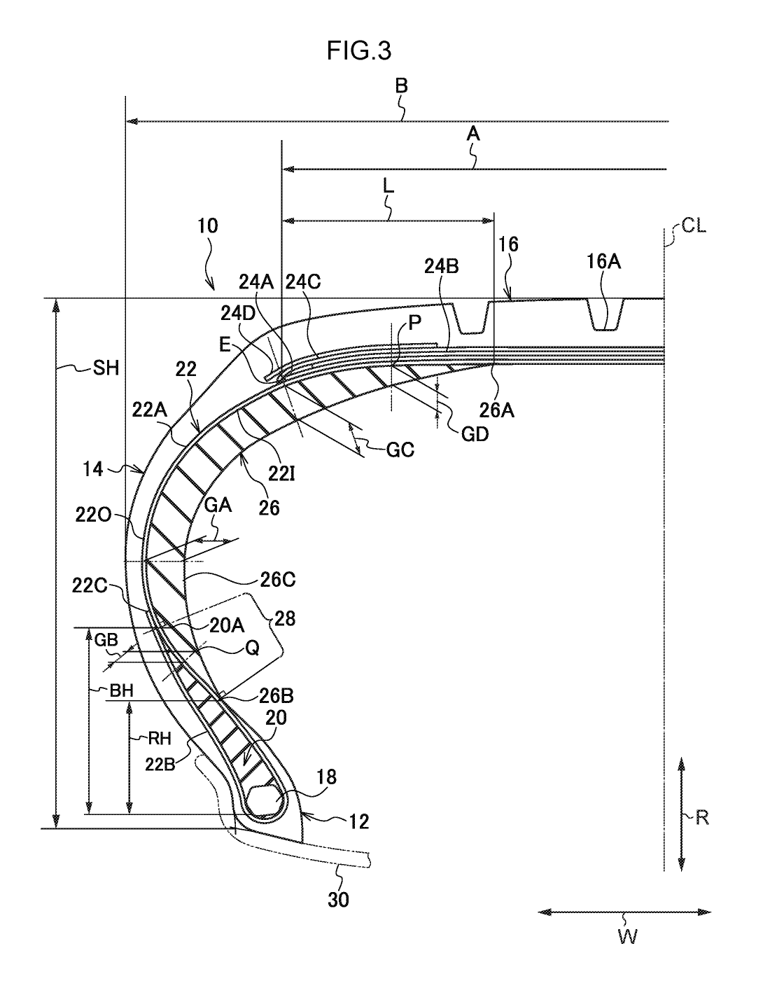

As shown in FIG. 3, a reinforcing cord layer 24D may be provided at an upper portion of the cap layer 24C at the tire radial direction outer side of the carcass 22. It is preferable if cords that constitute the reinforcing cord layer 24D are provided to be angled with respect to the tire circumferential direction in a range from at least 60° to at most 90°. By the addition of this reinforcing cord layer 24D, a bending stiffness in the vicinity of the position P that is 14% of the tire section height SH to the tire axial direction inner side from the tire axial direction end portion E of the belt layer 24A and the like is improved. Thus, buckling of the tire side portion 14 may be even further suppressed.

If the reinforcing cord layer is plurally provided, this effect is increased. However, because tire weight would increase, a single layer is provided in the present exemplary embodiment.

A rubber member at the tire axial direction outer side of the carcass 22 of the tire side portion 14 is not defined in the present exemplary embodiment but may include, for example, a rubber with the characteristics that a JIS hardness (at 20° C.) is 70-85 and a loss coefficient tan δ (at 60° C.) is not more than 0.10.

Hereabove, exemplary embodiments of the present invention have been described but the present invention is not limited by these exemplary embodiments. It will be clear that numerous modes may be embodied within a technical scope not departing from the gist of the present invention.

### Test Examples

In order to verify the effects of the present invention, nine kinds of run-flat radial tire (below referred to simply as tires) encompassed by the present invention (below referred to as Examples 1 to 9) and two kinds of comparative example run-flat radial tire not encompassed by the present invention (below referred to as Comparative Examples 1 and 2) were prepared and tested as follows.

First, the run-flat radial tires according to Examples 1 to 9 and the run-flat radial tires according to Comparative Examples 1 and 2 used in the testing are described. The sizes of these run-flat radial tires are all 215/60R17, and the tire section heights are all 129 mm.

The run-flat radial tires according to Examples 1 to 6 all employ structures the same as the structure of the tire 10 according to the present exemplary embodiment described above. The run-flat radial tires according to Examples 1 to 4 are tires with respectively different values of “the thickness GD of the side reinforcement rubber layer at position P that is 14% of the tire section height SH to the tire axial direction inner side from the maximum width angled belt end portion”.

The run-flat radial tires according to Examples 5 and 6 are tires with respectively different values of “the thickness GC of the side reinforcement rubber layer at the maximum angled belt end portion” and “the thickness GD of the side reinforcement rubber layer at position P that is 14% of the tire section height SH to the tire axial direction inner side from the maximum width angled belt end portion”.

The run-flat radial tire according to Comparative Example 1 has the same structure as the run-flat radial tires according to Examples 1 to 4 but the ratio (L/SH) of the overlap length L between the maximum width angled belt layer and the side reinforcement rubber layer to the tire section height SH is not encompassed by the present invention. Various quantitative values of Examples 1 to 4 and Comparative Example 1 are as shown in Table 1.

The run-flat radial tire according to Comparative Example 2 has the same structure as the run-flat radial tires according to Examples 5 and 6 but the ratio (GD/GA) of “the thickness GD of the side reinforcement rubber layer at position P that is 14% of the tire section height SH to the tire axial direction inner side from the maximum width angled belt layer end portion” to “the thickness GA of the side reinforcement rubber layer at the carcass maximum width position” is not encompassed by the present invention. Various quantitative values of Examples 5 and 6 and Comparative Example 2 are as shown in Table 2.

The run-flat radial tires according to Examples 7 to 9 are tires with respectively different values of “the tire axial direction width A of the maximum angled belt layer end portion”. Various quantitative values of Examples 7 to 9 are as shown in Table 3.

In the testing, first, a test tire was assembled to the standard rim defined by JATMA, mounted to a vehicle without being filled with air (i.e., with the internal pressure at 0 kPa), and preparatorily run for a distance of 5 km at a speed of 20 km/h. Then, the vehicle progressed at a predetermined speed into a turning path with a radius of curvature of 25 m and stopped at a position at a third of a circuit of the turning path, twice in succession (i.e., a J-turn test). This J-turn test was carried out with the progress speed being raised in increments of 2 km/h. A turning acceleration at which a bead portion disengaged from the rim (from a hump of the rim) was measured.

Using the turning acceleration at which the bead portion of Comparative Example 1 disengaged from the rim as a standard value (100), the turning accelerations at which the bead portions of Comparative Example 2 and Examples 1 to 6 disengaged from the rim were represented by indexes and evaluated. The roll-off resistances referred to in Table 1 to Table 3 represent the turning accelerations at which the bead portions disengaged from the rims by these indexes. The greater the numerical value of a roll-off resistance, the more excellent the result.

TABLE 1

| | | Comparative | Comparative | | | | |
|---|---|---|---|---|---|---|---|
| | | Example. 1 | Example 2 | Example 1 | Example 2 | Example 3 | Example 4 |
| Tire section width | B (mm) | 215 | 215 | 215 | 215 | 215 | 215 |
| Tread width | (mm) | 170 | 170 | 170 | 170 | 170 | 170 |
| Maximum width | Width A (mm) | 160 | 160 | 160 | 160 | 160 | 160 |
| angled belt layer | Overlap length L with side reinforcement rubber | 18 | 52 | 52 | 52 | 52 | 52 |
| | layer (mm) | | | | | | |
| | L/A | 11% | 32% | 32% | 32% | 32% | 32% |
| | L/tire section height SH | 14% | 40% | 40% | 40% | 40% | 40% |
| | A/B | 74% | 74% | 74% | 74% | 74% | 74% |
| Side Reinforcement | Crosses equatorial plane? | No | No | No | No | No | No |
| rubber layer | Thickness GA at carcass maximum width position | 9.0 | 9.0 | 9.0 | 9.0 | 9.0 | 9.0 |
| | Thickness GD at position 14% of the tire section | 0.0 | 1.8 | 2.7 | 4.5 | 4.7 | 4.9 |
| | height SH to the inner side from the maximum | | | | | | |
| | width angled belt layer end portion | | | | | | |
| | Thickness GC at maximum width angled belt layer | 4.0 | 6.5 | 6.5 | 6.5 | 6.5 | 6.5 |
| | end portion | | | | | | |
| | GD/GA | 0% | 20% | 30% | 50% | 52% | 54% |
| | GC/GA | 44% | 72% | 72% | 72% | 72% | 72% |
| Result | Roll-off resistance | 100 | 110 | 115 | 130 | 132 | 134 |

In Examples 1 to 4, the overlap length L was set to not less than 14% of the tire section height SH and the ratio GD/GA between the thickness GD and the thickness GA was not less than 30%. It was confirmed that the roll-off resistance improved remarkably in Examples 1 to 4.

TABLE 2

| | | Comparative | Comparative | | | |
|---|---|---|---|---|---|---|
| | | Example 1 | Example 2 | Example 1 | Example 5 | Example 6 |
| Tire section width | B (mm) | 215 | 215 | 215 | 215 | 215 |
| Tread width | (mm) | 170 | 170 | 170 | 170 | 170 |
| Maximum width angled | Width A (mm) | 160 | 160 | 160 | 160 | 160 |
| belt layer | Overlap length L with side reinforcement rubber layer | 18 | 52 | 52 | 52 | 52 |
| | (mm) | | | | | |
| | L/A | 11% | 32% | 32% | 32% | 32% |
| | L/tire section height SH | 14% | 40% | 40% | 40% | 40% |
| | A/B | 74% | 74% | 74% | 74% | 74% |
| Side Reinforcement | Crosses equatorial plane? | No | No | No | No | No |
| rubber layer | Thickness GA at carcass maximum width position | 9.0 | 9.0 | 9.0 | 9.0 | 9.0 |
| | Thickness GD at position 14% of the tire section height | 0.0 | 1.8 | 2.7 | 4.4 | 4.7 |
| | SH to the inner side from the maximum width angled belt | | | | | |
| | layer end portion | | | | | |
| | Thickness GC at maximum width angled belt layer end | 4.0 | 6.5 | 6.5 | 8.1 | 8.5 |
| | portion | | | | | |
| | GD/GA | 0% | 20% | 30% | 49% | 52% |
| | GC/GA | 44% | 72% | 72% | 90% | 94% |
| Result | Roll-off resistance | 100 | 110 | 115 | 128 | 132 |

As shown in Table 2, it was verified that the roll-off resistance was excellent in Examples 5 and 6 with the ratio GC/GA of the thickness GC to the thickness GA being 90% or more.

TABLE 3

| | | Example 7 | Example 8 | Example 9 |
|---|---|---|---|---|
| Tire section | B (mm) | 215 | 215 | 215 |
| width | | | | |
| Tread width | (mm) | 170 | 170 | 170 |
| Maximum | Width A (mm) | 160 | 172 | 183 |
| width angled | Overlap length L with side | 39 | 39 | 39 |
| belt layer | reinforcement rubber layer (mm) | | | |
| | L/A | 24% | 23% | 21% |
| | L/tire section height SH | 30% | 30% | 30% |
| | A/B | 74% | 80% | 85% |
| Side | Crosses equatorial plane? | No | No | No |
| Reinforcement | Thickness GA at carcass maximum | 9.0 | 9.0 | 9.0 |
| rubber layer | width position | | | |
| | Thickness GD at position 14% of the tire | 4.0 | 4.0 | 4.0 |
| | section height SH to the inner side from | | | |
| | the maximum width angled belt layer | | | |
| | end portion | | | |
| | Thickness GC at maximum width angled | 6.5 | 6.5 | 6.5 |
| | belt layer end portion | | | |
| | GD/GA | 44% | 44% | 44% |
| | GC/GA | 72% | 72% | 72% |
| Result | Roll-off resistance | 125 | 130 | 135 |

As shown in Table 3, in Examples 8 and 9 the tire axial direction width A of the belt layer 24A that is the maximum width angled belt layer was not less than 80% of the tire section width B. Consequently, it was verified that the roll-off resistance was further improved compared to Example 7 in which the tire axial direction width A was less than 80% of the tire section width B.

The disclosures of Japanese Patent Application No. 2014-086794 filed Apr. 20, 2014 are incorporated into the present specification by reference in their entirety.

All references, patent applications and technical specifications cited in the present specification are incorporated by reference into the present specification to the same extent as if the individual references, patent applications and technical specifications were specifically and individually recited as being incorporated by reference.

1. A side-reinforced type run-flat radial tire comprising:
a carcass that bridges between a pair of bead portions;
a side reinforcement rubber layer that is provided at a tire side portion and extends in a tire radial direction along an inner face of the carcass; and
angled belt layers that are provided at the tire radial direction outer side of the carcass and are provided with cords extending in directions that are angled with respect to a tire circumferential direction,
wherein the following relationships (1) and (2) are satisfied and a tire section height is at least 115 mm:
L>0.14×SH (1)
GD/GA≧0.3 (2)
in which relationships,
L represents an overlap length in a tire axial direction, at one side, between the side reinforcement rubber layer and a maximum width angled belt layer whose width in the tire axial direction is largest,
SH represents the tire section height,
GD represents a thickness of the side reinforcement rubber layer at a position that is 14% of the tire section height to the tire axial direction inner side from a tire axial direction end portion of the maximum width angled belt layer, and
GA represents a thickness of the side reinforcement rubber layer at a maximum width position of the carcass.

2. The side-reinforced type run-flat radial tire according to claim 1, wherein the following relationship (3) is satisfied:
GC/GA≧0.9 (3)
in which relationship GC represents a thickness of the side reinforcement rubber layer at the tire axial direction end portion of the maximum width angled belt layer.

3. The side-reinforced type run-flat radial tire according to claim 1, wherein the width in the tire axial direction of the maximum width angled belt layer is at least 80% of a tire section width.

4. The side-reinforced type run-flat radial tire according to claim 2, wherein the width in the tire axial direction of the maximum width angled belt layer is at least 80% of a tire section width.
